(19) United States
(12) Patent Application Publication
(10) Pub. No.: US 2003/0051077 A1
(43) Pub. Date: Mar. 13, 2003

(54) System and method for providing instruction to a peripheral device user

(76) Inventor: Lynda Fengler, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/950,120

(22) Filed: Sep. 10, 2001

(51) Int. Cl. G06F 3/00

(52) U.S. Cl. 710/8

(57) ABSTRACT

The present disclosure relates to a system and method for providing instruction to a peripheral device user. In one arrangement, the system and method involve receiving a request for instruction and presenting video data demonstrating performance of a designated task associated with a peripheral device. The video instruction can pertain to various different topics including, for instance, peripheral device set-up, software installation, peripheral device use, and peripheral device maintenance. The video data can be presented to the user with a display of a computing device used to access the peripheral device, or on a display of the peripheral device itself.

### FIELD OF THE INVENTION

The present disclosure relates to a system and method for providing instruction to a peripheral device user. More particularly, the disclosure relates to a system and method with which video instruction can be presented to the user that demonstrates how to perform various tasks associated with set-up, installation, use, and/or maintenance of the device.

### BACKGROUND OF THE INVENTION

When one purchases a peripheral device, he or she is normally called upon to set-up and install the device. Involved in this process are various tasks including, for example, removing the device from its box, assembling the device where device components (e.g., toner cartridge) are packed separately, installing various software on a computing device (e.g., personal computer (PC)) that will be used to access and control the peripheral device, and so forth. Besides tasks associated with device initialization, the user may, from time to time, be called upon to perform other tasks associated with device use and maintenance. For example, the user may need to periodically replace a toner cartridge or other consumable component of the device.

In that the user normally is, at least at first, unfamiliar with the procedures for completing the aforementioned tasks, the user typically requires instruction on how to perform the tasks. Today, most peripheral devices come supplied with a hardcopy and/or electronic user's manual that explains how to set-up, install, use, and maintain the peripheral device. Although the manual can be used as a reference during device initialization and during periodic use and maintenance, such a manual is of limited benefit to the user in that the guidance provided within the manual typically is limited to cryptic written descriptions and schematics intended to explain how to perform the various tasks. Accordingly, despite being provided with the manual, the user may still have difficulty in completing one or more tasks associated with the peripheral device.

From the foregoing, it can be appreciated that it would be desirable to have a system and method for providing instruction to a peripheral device user that is more beneficial to the user than conventional user manuals.

### SUMMARY OF THE INVENTION

The present disclosure relates to a system and method for providing instruction to a peripheral device user. In one arrangement, the system and method involve receiving a request for instruction and presenting video data demonstrating performance of a designated task associated with a peripheral device. As is discussed herein, the video instruction can pertain to various different topics including, for instance, peripheral device set-up, software installation, peripheral device use, and peripheral device maintenance. The video data can be presented to the user with a display of a computing device used to access the peripheral device, or on a display of the peripheral device itself.

Where the video instruction is to be presented to the user with the peripheral device display, data relevant to the video instruction can be stored within the peripheral device. In such an embodiment, the peripheral device can comprise operation hardware, memory including a video instructor, the video instructor having a video player and at least one video file, and a display adapted to present video instruction to a user.

The features, and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic view of an example system for providing video instruction.

FIG. 2 is a schematic view of a peripheral device shown in FIG. 1.

FIG. 3 is a schematic view of a network device shown in FIG. 1.

FIG. 4 is a flow diagram that illustrates the operation of video instructors of a storage medium shown in FIG. 1 and the network device shown in FIG. 3.

FIG. 5 is a flow diagram that illustrates the operation of a video instructor of the peripheral device shown in FIG. 2.

### DETAILED DESCRIPTION

Disclosed herein is a system and method for providing instruction to a peripheral user to help the user perform various tasks pertinent to the peripheral device. For instance, the user can obtain help in setting-up the peripheral device including making all necessary electrical cable connections, initializing the peripheral for use including installation of all relevant software required on the host device, using the peripheral including adjusting its settings, and maintaining the peripheral including remedying fault conditions experienced by the peripheral. As is described in greater detail below, the instruction is provided through the presentation of various video data, in the form of actual footage, to the user. This video data can be presented to the user with a display of the host device, peripheral device, or both.

To facilitate description of the system and method, an example system will first be discussed with reference to the figures. Although this system is described in detail, it will be appreciated that this system is provided for purposes of illustration only and that various modifications are feasible without departing from the inventive concept. After the example system has been described, examples of operation of the system will be provided to explain the manners in which instruction can be provided.

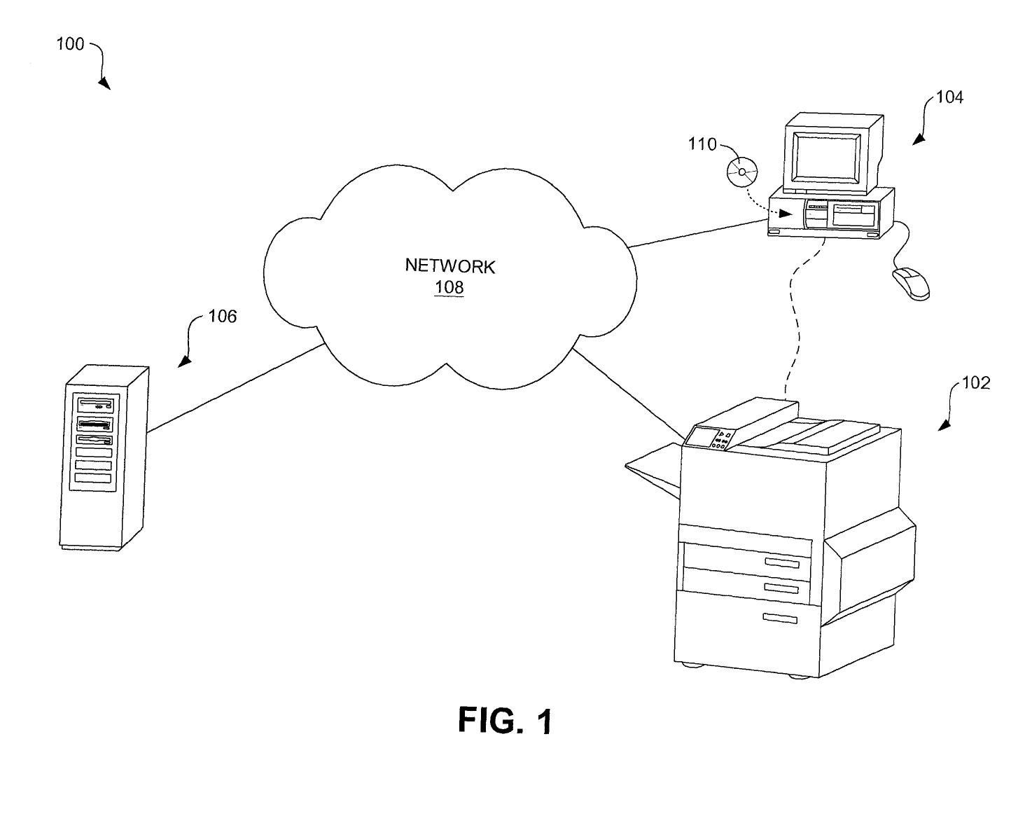

Referring now in more detail to the drawings, in which like numerals indicate corresponding parts throughout the several views, FIG. 1 illustrates an example system 100 for providing video instruction. As indicated in this figure, the system 100 generally comprises a peripheral device 102. By way of example, this peripheral device 102 comprises a printer. However, it is to be understood that the peripheral device 102 can comprise substantially any other type of peripheral device including a photocopier, facsimile machine, scanner, multifunction peripheral, network appliance, etc.

In addition to the peripheral device 102, the system 100 can include a computing device 104. The computing device 104 comprises substantially any device that is capable of use with the peripheral device 102 and, more particularly, which is capable of communicating with the peripheral device by transmitting data to and/or receiving data from the peripheral device. By way of example, the computing device 104 comprises a personal computer (PC). Although a PC is identified in FIG. 1 and discussed herein, it will be appreciated that the computing device 104 could, alternatively, comprise another type of computing device including, for instance, a notebook computer, a server, a personal digital assistant (PDA), a mobile telephone, etc.

As is further identified in FIG. 1, the system 100 can also include a network device 106 that stores various information. By way of example, the network device 106 comprises a network server. The peripheral device 102, computing device 104, and network device 106 can each be connected to a network 108 that typically comprises one or more sub-networks that are communicatively coupled to each other. By way of example, these networks can include one or more local area networks (LANs) and/or wide area networks (WANs). Indeed, in some embodiments, the network 108 may comprise a set of networks that forms part of the Internet. As is depicted in FIG. 1, the computing device 104 can be directly connected to the peripheral device 102. Such an arrangement is likely in a home or small office environment in which the user does not use a network and instead directly communicates to the peripheral device 102. In such a scenario, communication can be facilitated with a direct electrical and/or optical connection or through wireless communication.

As is further indicated in FIG. 1, the system 100 can include a storage medium 110 that, by way of example, comprises a read-only compact disk (CDROM). As discussed in greater detail below, the storage medium 110 can be provided to the user along with the peripheral device 102 to help the user set-up, install, use, and maintain the device. To ensure that the user locates the storage medium 110, it can be prominently placed and marked within the peripheral device packaging to catch the user's attention. As is discussed below in greater detail, the storage medium 110 can comprise video instructor software with which video data can be presented to the user on the computing device 104.

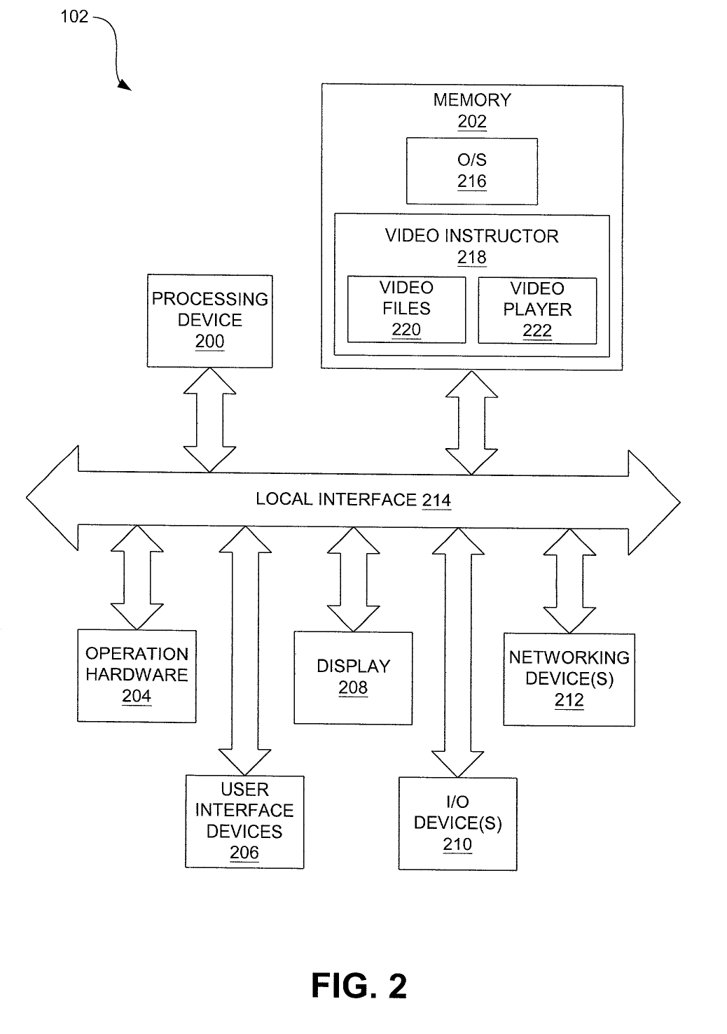

FIG. 2 is a schematic view illustrating an example architecture for the peripheral device 102 shown in FIG. 1. As indicated in FIG. 2, the peripheral device 102 can comprise a processing device 200, memory 202, operation hardware 204, one or more user interface devices 206, a display 208, one or more input/output (I/O) devices 210, and one or more networking devices 212. Each of these components is connected to a local interface 214 that, by way of example, comprises one or more internal buses. The processing device 200 is adapted to execute commands stored in memory 202 and can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the peripheral device 102.

The operation hardware 204 comprises the various components that provide for performance of the various functionalities for which the peripheral device 102 is configured. For instance, where the peripheral device 102 comprises a printer, the operation hardware may comprise a print engine. The one or more user interface devices 206 typically comprise interface tools with which the device settings can be changed and through which the user can directly communicate commands to the peripheral device 102. By way of example, the user interface devices 206 comprise one or more function keys and/or buttons with which the operation of the peripheral device 102 can be controlled. More particularly, the user interface devices may comprise various video-centric buttons such as a play button, stop button, fast forward button, rewind, button, etc.

The display 208 is used to present visual information to the user and, as is described below, to present video data to the user. By way of example, the display 208 comprises a liquid crystal display (LCD). Notably, where the display 208 comprises a touch-sensitive screen, the display can also be considered a user interface device in that it can be used to enter various commands. Preferably, the display 208 is relatively large so as to provide an appropriate medium for the viewing video data.

With further reference to FIG. 2, the one or more I/O devices 210 are adapted to facilitate connection of the peripheral device 102 to another device, such as a computing device 104, and may therefore include one or more serial, parallel, small computer system interface (SCSI), universal serial bus (USB), IEEE 1394 (e.g., Firewire™), and/or personal area network (PAN) components. The one or more networking devices 212 comprise the various components used to transmit and/or receive data over the network 108. By way of example, the networking devices 212 include a device that can communicate both inputs and outputs, for instance, a modulator/demodulator (e.g., modem), a wireless (e.g., radio frequency (RF)) transceiver, a telephonic interface, a bridge, a router, a network card, etc.

The memory 202 includes various software (e.g., firmware) programs including an operating system 216 and a video instructor 218. The operating system 216 contains the various commands used to control the general operation of the peripheral device 102. As is described below in greater detail, the video instructor 218 is configured to present video instruction to the user via the display 208. By way of example, the video instructor 218 comprises a plurality of video files 220 and a video player 222 that is configured for “playing” the video files. The video files 220 can comprise, for example, compressed files stored in a known video format such as MPEG. Although MPEG has been explicitly identified herein, persons having ordinary skill in the art will appreciate that other video formats may be used. The video instructor 218 can, for instance, be stored on a non-volatile storage medium such as an internal CDROM or in a dual in-line memory module (DIMM) on a formatter board of the peripheral device 102. A DIMM may be preferable for cases in which the peripheral device 102 has been programmed with video data from the factory. Alternatively, the video data can be stored on a device hard drive. Normally, however, this would be a temporary solution to avoid the risk of writing over the data by mistake. However, storage on the hard drive would permit the user to download newer versions of the video data from the Internet to the hard drive. In yet another alternative, newer visions of the video data can be downloaded from the Internet to flash memory of the device 102.

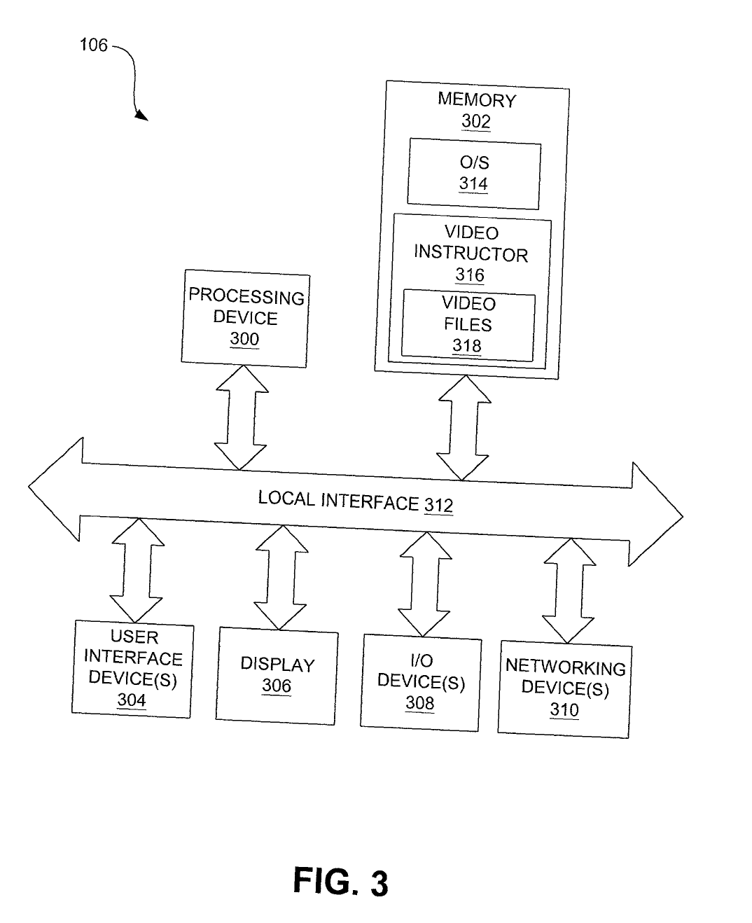

FIG. 3 is a schematic view illustrating an example architecture for the network device 106 shown in FIG. 1. As indicated in FIG. 3, the network device 106 can comprise a processing device 300, memory 302, one or more user interface devices 304, a display 306, one or more I/O devices 308, and one or more networking devices 310, each of which are connected to a local interface 312. The processing device 300 can include any custom made or commercially available processor, a central processing unit (CPU) or an auxiliary processor among several processors associated with the network device 106, a semiconductor based microprocessor (in the form of a microchip), or a macroprocessor. The memory 302 can include any one of a combination of volatile memory elements (e.g., random access memory (RAM, such as DRAM, SRAM, etc.)) and nonvolatile memory elements (e.g., ROM, hard drive, CDROM, tape, etc.).

The one or more user interface devices 304 comprise those components with which the user can interact with the network device 106. For example, where the network device 106 comprises a PC or server, these components can comprise a keyboard and mouse. In addition, the display 306 can comprise a computer monitor or plasma screen for a PC or server. The one or more I/O devices 308 and the one or more networking devices 310 operate as and can have similar configuration to the like-named components described above with relation to FIG. 2.

The memory 302 normally comprises an operating system 314 and a video instructor 316 that includes one or more video files 318. The operating system 314 controls the execution of other software and provides scheduling, input-output control, file and data management, memory management, and communication control and related services. The video instructor 316, like instructor 218, is configured to present video instruction to the user. While this instruction can be provided to the user with the display 208 of the peripheral device 102, the instruction is also available to the computing device 104 (e.g., on a monitor).

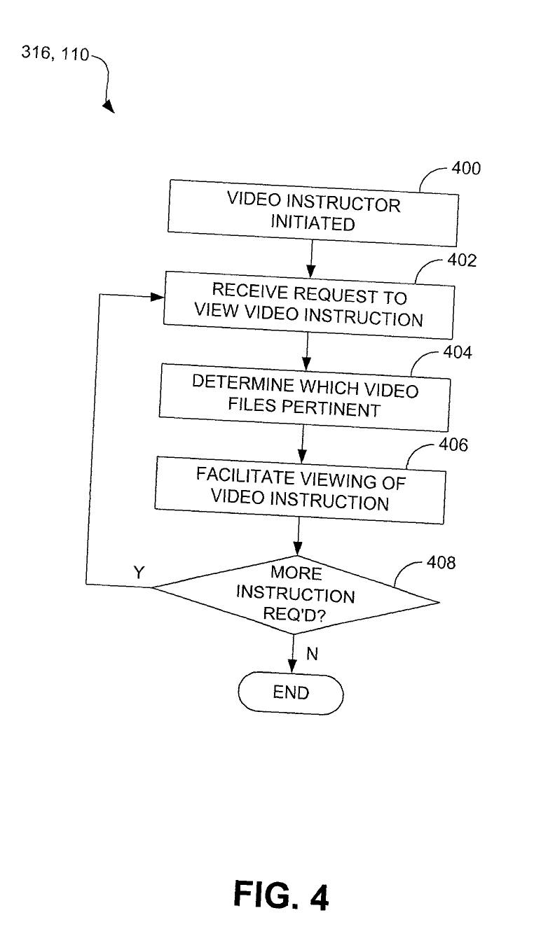

As noted above, the storage medium 110 shown in FIG. 1 can also comprise its own video instructor software (not shown). This instructor can be similar in configuration to that of the network device 106. When inserted into the computing device 104, the instructor can be opened and used in similar manner to the like-named component of the network device 106. Accordingly, the software stored on the storage medium 110 will be described in conjunction with the video instructor 316 of the network device 106 in FIG. 4.

Various software and/or firmware programs have been described herein. It is to be understood that these programs can be stored on any computer readable medium for use by or in connection with any computer related system or method. In the context of this document, a computer readable medium is an electronic, magnetic, optical, or other physical device or means that can contain or store a computer program for use by or in connection with a computer related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

An example system 100 having been described above, operation of the system will now be discussed. In the discussion that follows, flow diagrams are provided. It is to be understood that any process steps or blocks in these flow diagrams represent modules, segments, or portions of code that include one or more executable instructions for implementing specific logical functions or steps in the process. It will be appreciated that, although particular example process steps are described, alternative implementations are feasible. Moreover, steps may be executed out of order from that shown or discussed, including substantially concurrently or in reverse order, depending on the functionality involved.

Generally speaking, operation of the system involves providing video instruction to a user in various different contexts. In a first context, the user can receive video instruction regarding set-up and installation for the peripheral device 102. In a second context, the user can receive video instruction regarding use of the peripheral device 102. In a third context, the user can receive video instruction regarding maintenance of the peripheral device 102. In each context, greater benefit is provided to the user as compared with that received from a user manual in that actual video footage of a person performing various tasks on the same model peripheral device can be provided. Accordingly, the user can view step-by-step demonstrations with the device to help the user understand and learn how to complete various different device-related tasks.

In addition to the various different contexts for which video instruction can be provided, the video instruction can be presented to the user in a variety of ways. In a first arrangement, the video instruction is presented to the user on a display of the user's computing device 104. This variety of presentation is particularly useful for receiving instruction regarding set-up and installation as well as use of the peripheral device 102. As is discussed below, this video instruction can be retrieved either from the storage medium 110 or from the remote device 106 via the network 108. In a second arrangement, the video instruction can be provided to the user with the display 208 of the peripheral device 102 itself. This video instruction can be retrieved from the device memory 202, or again from the network device 106. Presentation of the video instruction on the display 208 is particularly useful to the user for instruction regarding use and maintenance of the peripheral device 102.

FIG. 4 illustrates operation of the video instructor 316 of the network device 106 in providing video instruction regarding set-up and installation of the peripheral device 102. In that the storage medium 110 comprises a video instructor (i.e., software) that is similar to the video instructor 316, it will be appreciated that the discussion that follows applies equally to the storage medium software. With reference to block 400, the video instructor is first initiated. This initiation can occur in a variety of ways. For example, where the video instructor is that stored on the network device 106, initiation can occur in response to a user accessing a network site (e.g., web site) with his or her computing device 104 via the network 108. Alternatively, where the video instructor is stored on the storage medium 110, initiation can occur when the user first inserts the storage medium into an appropriate drive of the computing device 104 or when the user “opens” the video instructor from a start-up menu.

In any case, once the video instructor 316 has been initiated, it can receive a request to view video instruction, as indicated in block 402. In that the video instructor 316 comprises various different video files 220 pertinent to various different peripheral device topics, the video instructor first determines which video files are pertinent to the request, as indicated in block 404. With regard to peripheral device set-up, implicated video files may pertain to removing the peripheral device 102 from its box, providing power to the device, connecting the various data cables to the device, installing various components within the peripheral device (e.g., toner cartridges, developer drums, etc.), installing accessories on the peripheral device (e.g., supplemental trays), and so forth. By way of example, these video files may be implicated as a group where the video instructor 316 determines that the user is initializing a newly obtained peripheral device 102. This determination can, for instance, be made based upon a user response to a prompt presented after the video instructor 316 is initiated.

With regard to installation, video files that pertain to software installation (e.g., driver installation) can be implicated. In particular, one or more video files that provide instruction to the user as to the various available options can be implicated that present demonstrations to the user regarding these options. Again, in that video footage is presented to the user, the user will be able to watch another person install the software step-by-step. In addition to this form of instruction, tips can be provided to the user as to how to optimize the peripheral device for the particular type of use that he or she foresees.

Once the pertinent video files have been determined, the video instructor 316 facilitates viewing of the video with the computing device 104 or peripheral device 102, as indicted in block 406. As with initiation, this facilitation can take several different forms. For example, where the video instructor is that of the network device, facilitation can comprise transmission of the various implicated video files to the computing device 104 or peripheral device 102. In such a situation, a video-player (e.g., RealPlayer™) can be used to “play” the video data. Alternatively, the video files can be “played” on the network device 106 and viewed with the computing device 104 or peripheral device 102 as a streaming video transmission. Where the video instructor resides on the storage medium 110, facilitation can merely comprise uploading the various implicated video files to the appropriate video player stored on the computing device 104.

Irrespective of how viewing is facilitated, video data is ultimately displayed to the user. As noted above, this data includes actual demonstrations with actual devices to explicitly show the user how to perform various tasks. Where a particular task is to be completed, for instance making various cable connections, the user can be shown video footage of a person actually making these connections on the same model peripheral device. Accordingly, far more effective instruction can be provided to the user, thereby potentially reducing the amount of customer support that must be provided by the device manufacturer for the peripheral device 102.

Returning to FIG. 4, flow next continues to decision element 408 at which it can be determined whether more instruction is required by the user. If not, flow is terminated. If further instruction is required, however, flow returns to block 402 at which a further request for instruction can be received by the video instructor and from which flow can continue in the manner described above. Notably, the video instruction can be obtained from both the network device 106 and the storage medium 110. By way of example, the storage medium 110 can first be consulted for instruction as to a particular topic. If no video instruction exists for that topic on the storage medium 110, the user could then be prompted to search for applicable video instruction from a network site (e.g., web site) supported by the network device 106. In another example, even if video instruction is provided for a particular topic, the user may still wish to visit the applicable network site to check for updated instruction. Operating in this manner, the most recent and/or newly available video instruction can be provided to the user.

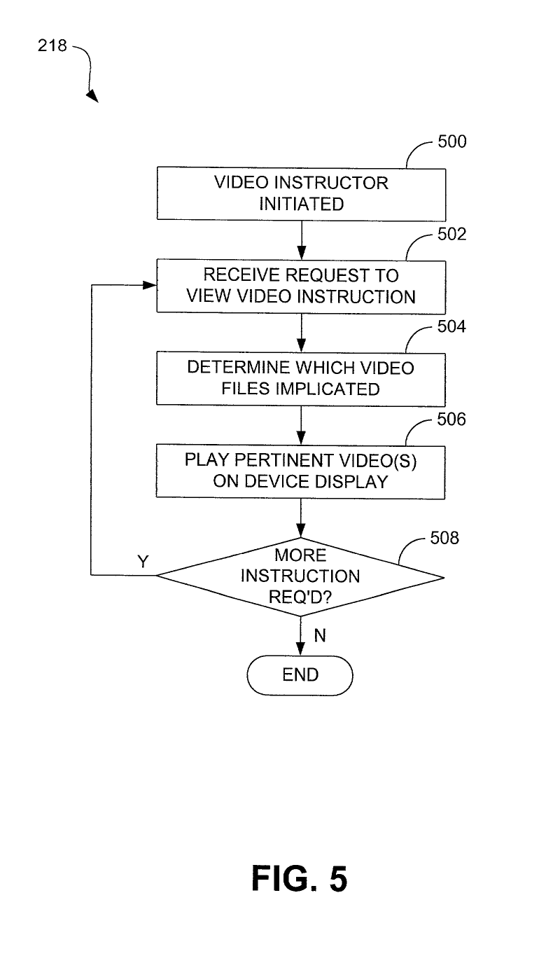

FIG. 5 illustrates operation of the video instructor 218 in providing video instruction regarding use and/or maintenance of the peripheral device 102. In this scenario, video data is viewed on the display 208 of the peripheral device 102 itself. Due to this fact, the user can view video instruction while in front of the peripheral device. Therefore, the user can immediately apply what he or she has just learned from the video instruction to the peripheral device 102. In terms of device use, the user can be provided with general instruction as to how to operate the peripheral device 102. For instance, instruction can be provided as to the meaning of the device various device settings and how they affect device performance. In addition, video instruction can be provided as to how to obtain the best results for the particular type of use in which the user is interested.

In terms of device maintenance, video instruction can be provided for remedying various fault conditions that arise with the peripheral device's operation. For instance, if the peripheral device 102 runs out of toner, video instruction can be viewed that demonstrates how to remove an old toner cartridge and replace it with a new one. Where the maintenance is performed in response to a condition sensed by the device 102, appropriate video instruction can be automatically made available to the user for immediate use. For instance, where the peripheral device 102 experiences a paper jam, the device 102 could alert the user as to the condition and offer video data to the user that shows how to fix that particular type of paper jam. Operating in this manner, the user would not need to browse through a menu of possible topics available for viewing before finally locating the desired video data. In addition to video instruction regarding the remedying of device problems, video instruction can also be provided for other routine maintenance of the peripheral device 102. For example, video data can be made available for loading the device 102 with paper, changing developer drums, etc.

FIG. 5 provides an example of operation of the video instructor 218 of the peripheral device 102. Although the video instructor 218 is identified in FIG. 5 and described herein, it is to be understood that the various video instruction provided by the instructor 218 in the user/maintenance context could, alternatively, be provided by the video instructor 318 of the network device 102 if the peripheral device 102 is network enabled.

Referring now to block 500 of FIG. 5, the video instructor 218 is first initiated. Again, this initiation can occur in various different ways. By way of example, initiation can occur in response to a request to view video instruction that is entered by the user with the user interface devices 206 of the peripheral device. In such a scenario, the user can have selected a “video instruction” button (not shown) that is provided on the peripheral device 102. In another example, as noted above, initiation can occur automatically in response to a fault condition sensed by the peripheral device 102.

Once the video instructor 218 has been initiated, it can receive a request to provide video instruction, as indicated in block 502. Where the video instructor 218 was initiated in response to a sensed fault condition, the “request” can comprise the occurrence of the condition itself. Where, on the other hand, the video instructor 218 has been affirmatively initiated by the user, the request can be communicated to the peripheral device in the form of a selection that has been made by the user. In such a scenario, the user can, for instance, select a topic from a list of available topics for which there is video instruction that is presented to the user on the display 208. Optionally, the user could further conduct searches of the topics, if desired.

Once the request is received, the video instructor 218 determines which video files are implicated, as indicated in block 504. After the particular video files have been identified, the video instructor 218 “plays” the videos on the device display 208, as indicated in block 506. In particular, the video instructor 218 activates the video player 222 and uploads the various pertinent video files 220 to the player for presentation. Where the user interface devices 206 include the typical video-centric buttons as identified above, the user can manipulate the video data (e.g., play, replay, fast forward) to best suit his or her needs.

At this point, flow continues to decision element 508 at which it can be determined whether more instruction is required by the user. If not, flow is terminated. If, on the other hand, further instruction is required, flow returns to block 502 at which a further request for instruction can be received by the video instructor 218.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for providing peripheral device instruction, comprising the steps of:
receiving a request for instruction; and
presenting video data demonstrating performance of a designated task associated with a peripheral device.

2. The method of claim 1, wherein the step of receiving a request comprises receiving a request for instruction from a user.

3. The method of claim 1, wherein the step of receiving a request comprises sensing of a peripheral device fault condition.

4. The method of claim 1, wherein the step of presenting video data comprises displaying video data on a display of a user computing device.

5. The method of claim 1, wherein the step of presenting video data comprises displaying video data on a display of the peripheral device.

6. The method of claim 1, further comprising the step of retrieving video data used to display the video data from a storage medium accessible with a user computing device.

7. The method of claim 1, further comprising the step of retrieving video data used to display the video data from a remote network device via a network.

8. The method of claim 1, further comprising the step of retrieving video data used to display the video data from memory of the peripheral device.

9. A system for providing peripheral device instruction, comprising:
means for receiving a request for instruction; and
means for presenting video data demonstrating performance of a designated task associated with a peripheral device.

10. The system of claim 9, further comprising means for sensing a peripheral device fault condition.

11. The system of claim 9, wherein the means for presenting video data comprises a display of a user computing device.

12. The system of claim 9, wherein the means for presenting video data comprises a display of the peripheral device.

13. The system of claim 9, further comprising means for retrieving video data used to display video data.

14. A peripheral device, comprising:
operation hardware;
memory including a video instructor, the video instructor having a video player and at least one video file; and
a display adapted to present video instruction to a user.

15. The device of claim 14, wherein the at least one video file comprises at least one compressed video file in MPEG format.

16. The device of claim 14, wherein the video files pertain to at least one of peripheral device set-up, software installation, peripheral device use, and peripheral device maintenance.

17. The device of claim 14, wherein the peripheral device comprises a multifunction peripheral.
